(19) United States
(12) Patent Application Publication
(10) Pub. No.: US 2009/0282435 A1
(43) Pub. Date: Nov. 12, 2009

(54) Video Program Sequenced Output

(75) Inventors: Scott White, Austin, TX (US); James L. Cansler, Pflugerville, TX (US); Rama Narayanan, San Antonio, TX (US)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T Knowledge Ventures, L.P., Reno, NV (US)

(21) Appl. No.: 12/115,615

(22) Filed: May 6, 2008

(51) Int. Cl. H04N 5/445

(52) U.S. Cl. 725/38

(57) ABSTRACT

A method is disclosed and includes receiving a selection of a first video program, receiving a selection of a linking command to link the first video program to a second video program, receiving a user request to output the first video program to a display device, and outputting the first video program in response to the user request. The method further includes after displaying the first video program, automatically outputting the second video program to the display device without an additional user action.

### FIELD OF THE DISCLOSURE

The present disclosure is generally directed to a method and system to provide video program sequenced output.

### BACKGROUND

Video programs, especially those targeting young children, are typically of short duration, perhaps as short has 30 minutes. Parents allowing their children to watch multiple programs in a single viewing session may be faced with a need to manually start each of the programs, or else create a program playlist if the option to create the program playlist is present in playback equipment used. An alternative to complexities involved in creating program playlists may be desirable.

### BRIEF DESCRIPTION OF THE DRAWINGS

The present disclosure may be better understood, and its numerous features and advantages made apparent to those skilled in the art by referencing the accompanying drawings.

FIG. 1 is a diagram of a particular illustrative embodiment of a system to provide video program sequenced output.

FIG. 2 is a diagram of a particular illustrative embodiment of a system to provide video program sequenced output.

FIG. 3 is a block diagram of a particular illustrative embodiment of a method to provide video program sequenced output.

FIG. 4 is a diagram of a particular illustrative embodiment of a graphical user interface to provide video program sequenced output.

FIG. 5 is a diagram of an illustrative embodiment of a general computer system.

The use of the same reference symbols in different drawings indicates similar or identical items.

### DETAILED DESCRIPTION

A method and apparatus to provide video program sequenced output is disclosed. In a particular embodiment, the method includes receiving a selection of a first video program and receiving a selection of a linking command to link the first video program to a second video program. The method further includes receiving a user request to output the first video program to a display device, and outputting the first video program in response to the user request. The method also includes, after displaying the first video program, automatically outputting the second video program to the display device without an additional user action.

In a particular embodiment, an apparatus to link a plurality of video programs includes an input module configured to receive input including a selection of a first video program, a selection of a link command, and a selection of a second video program. The apparatus also includes video linking logic responsive to the input module, the video linking logic configured, in response to the input received at the input module, to link the first video program with the second video program to provide linked video programs. The apparatus further includes an output module responsive to the video linking logic, the output module configured to output the linked video programs such that the first video program is output in response to a user request and the second video program is automatically output without an additional user request after the first video program output has completed or is interrupted.

In a particular embodiment, a computer readable medium includes processor executable instructions that, when executed, cause the processor to receive a selection of a link command associated with a first video program and a second video program and link the second video program to the first video program. The computer readable medium further includes processor executable instructions that, when executed, cause the processor, in response to receiving a user command, to commence output of the first video program, and at a conclusion of outputting the first video program, to automatically commence output of the second video program linked to the first video program.

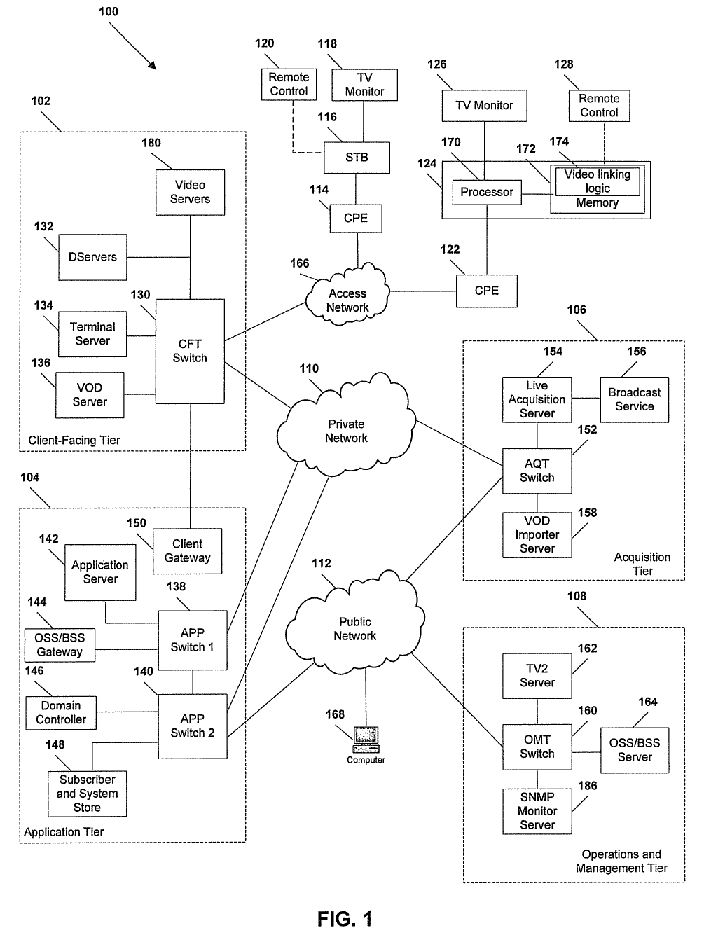

Referring to FIG. 1, an illustrative embodiment of an Internet Protocol Television (IPTV) system that may be used to provide video program sequenced output is illustrated and is generally designated 100. As shown, the system 100 can include a client facing tier 102, an application tier 104, an acquisition tier 106, and an operations and management tier 108. Each tier 102, 104, 106, 108 is coupled to a private network 110; to a public network 112, such as the Internet; or to both the private network 110 and the public network 112. For example, the client-facing tier 102 can be coupled to the private network 110. Further, the application tier 104 can be coupled to the private network 110 and to the public network 112. The acquisition tier 106 can also be coupled to the private network 110 and to the public network 112. Additionally, the operations and management tier 108 can be coupled to the public network 112.

As illustrated in FIG. 1, the various tiers 102, 104, 106, 108 communicate with each other via the private network 110 and the public network 112. For instance, the client-facing tier 102 can communicate with the application tier 104 and the acquisition tier 106 via the private network 110. The application tier 104 can communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104, including, but not limited to, a client gateway 150, can communicate directly with the client-facing tier 102.

The client-facing tier 102 can communicate with user equipment via an access network 166, such as an Internet Protocol Television (IPTV) access network. In an illustrative embodiment, customer premises equipment (CPE) 114, 122 can be coupled to a local switch, router, or other device of the access network 166. The client-facing tier 102 can communicate with a first representative set-top box device 116 via the first CPE 114 and with a second representative set-top box device 124 via the second CPE 122. In a particular embodiment, the first representative set-top box device 116 and the first CPE 114 can be located at a first customer premise, and the second representative set-top box device 124 and the second CPE 122 can be located at a second customer premise. In another particular embodiment, the first representative set-top box device 116 and the second representative set-top box device 124 can be located at a single customer premise, both coupled to one of the CPE 114, 122. The CPE 114, 122 can include routers, local area network devices, modems, such as digital subscriber line (DSL) modems, any other suitable devices for facilitating communication between a set-top box device and the access network 166, or any combination thereof.

In an exemplary embodiment, the client-facing tier 102 can be coupled to the CPE 114, 122 via fiber optic cables. In another exemplary embodiment, the CPE 114, 122 can be digital subscriber line (DSL) modems that are coupled to one or more network nodes via twisted pairs, and the client-facing tier 102 can be coupled to the network nodes via fiber-optic cables. Each set-top box device 116, 124 can process data received via the access network 166, via an IPTV software platform, such as Microsoft® TV IPTV Edition.

The first set-top box device 116 can be coupled to a first external display device, such as a first television monitor 118, and the second set-top box device 124 can be coupled to a second external display device, such as a second television monitor 126. Moreover, the first set-top box device 116 can communicate with a first remote control 120, and the second set-top box device 124 can communicate with a second remote control 128. The set-top box devices 116, 124 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 116, 124 can receive data, video, or any combination thereof, from the client-facing tier 102 via the access network 166 and render or display the data, video, or any combination thereof, at the display device 118, 126 to which it is coupled. In an illustrative embodiment, the set-top box devices 116, 124 can include tuners that receive and decode television programming signals or packet streams for transmission to the display devices 118, 126. Further, the set-top box devices 116, 124 can include a STB processor 170 and a STB memory device 172 that is accessible to the STB processor 170. In one embodiment, a computer program, such as video linking logic 174, can be embedded within the STB memory device 172.

In an illustrative embodiment, the client-facing tier 102 can include a client-facing tier (CFT) switch 130 that manages communication between the client-facing tier 102 and the access network 166 and between the client-facing tier 102 and the private network 110. As illustrated, the CFT switch 130 is coupled to one or more data servers, such as D-servers 132, that store, format, encode, replicate, or otherwise manipulate or prepare video content for communication from the client-facing tier 102 to the set-top box devices 116, 124. The CFT switch 130 can also be coupled to a terminal server 134 that provides terminal devices with a point of connection to the IPTV system 100 via the client-facing tier 102. In a particular embodiment, the CFT switch 130 can be coupled to a video-on-demand (VOD) server 136 that stores or provides VOD content imported by the IPTV system 100. Further, the CFT switch 130 is coupled to one or more video servers 180 that receive video content and transmit the content to the set-top boxes 116, 124 via the access network 166.

In an illustrative embodiment, the client-facing tier 102 can communicate with a large number of set-top boxes, such as the representative set-top boxes 116, 124, over a wide geographic area, such as a metropolitan area, a viewing area, a statewide area, a regional area, a nationwide area or any other suitable geographic area, market area, or subscriber or customer group that can be supported by networking the client-facing tier 102 to numerous set-top box devices. In a particular embodiment, the CFT switch 130, or any portion thereof, can include a multicast router or switch that communicates with multiple set-top box devices via a multicast-enabled network.

As illustrated in FIG. 1, the application tier 104 can communicate with both the private network 110 and the public network 112. The application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. In a particular embodiment, the application server 142 can provide applications to the set-top box devices 116, 124 via the access network 166, which enable the set-top box devices 116, 124 to provide functions, such as interactive program guides, video gaming, display, messaging, processing of VOD material and other IPTV content, etc. In an illustrative embodiment, the application server 142 can provide location information to the set-top box devices 116, 124. In a particular embodiment, the OSS/BSS gateway 144 includes operation systems and support (OSS) data, as well as billing systems and support (BSS) data. In one embodiment, the OSS/BSS gateway 144 can provide or restrict access to an OSS/BSS server 164 that stores operations and billing systems data.

The second APP switch 140 can be coupled to a domain controller 146 that provides Internet access, for example, to users at their computers 168 via the public network 112. For example, the domain controller 146 can provide remote Internet access to IPTV account information, e-mail, personalized Internet services, or other online services via the public network 112. In addition, the second APP switch 140 can be coupled to a subscriber and system store 148 that includes account information, such as account information that is associated with users who access the IPTV system 100 via the private network 110 or the public network 112. In an illustrative embodiment, the subscriber and system store 148 can store subscriber or customer data and create subscriber or customer profiles that are associated with IP addresses, stock-keeping unit (SKU) numbers, other identifiers, or any combination thereof, of corresponding set-top box devices 116, 124. In another illustrative embodiment, the subscriber and system store can store data associated with capabilities of set-top box devices associated with particular customers.

In a particular embodiment, the application tier 104 can include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto. In an illustrative embodiment, the set-top box devices 116, 124 can access the IPTV system 100 via the access network 166, using information received from the client gateway 150. User devices can access the client gateway 150 via the access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the access network 166.

For example, when the first representative set-top box device 116 accesses the client-facing tier 102 via the access network 166, the client gateway 150 can verify subscriber information by communicating with the subscriber and system store 148 via the private network 110. Further, the client gateway 150 can verify billing information and status by communicating with the OSS/BSS gateway 144 via the private network 110. In one embodiment, the OSS/BSS gateway 144 can transmit a query via the public network 112 to the OSS/BSS server 164. After the client gateway 150 confirms subscriber and/or billing information, the client gateway 150 can allow the set-top box device 116 to access IPTV content and VOD content at the client-facing tier 102. If the client gateway 150 cannot verify subscriber information for the set-top box device 116, e.g., because it is connected to an unauthorized twisted pair, the client gateway 150 can block transmissions to and from the set-top box device 116 beyond the access network 166.

As indicated in FIG. 1, the acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives or acquires television content, movie content, advertisement content, other video content, or any combination thereof, from a broadcast service 156, such as a satellite acquisition system or satellite head-end office. In a particular embodiment, the live acquisition server 154 can transmit content to the AQT switch 152, and the AQT switch 152 can transmit the content to the CFT switch 130 via the private network 110.

In an illustrative embodiment, content can be transmitted to the D-servers 132, where it can be encoded, formatted, stored, replicated, or otherwise manipulated and prepared for communication from the video server(s) 180 to the set-top box devices 116, 124. The CFT switch 130 can receive content from the video server(s) 180 and communicate the content to the CPE 114, 122 via the access network 166. The set-top box devices 116, 124 can receive the content via the CPE 114, 122, and can transmit the content to the television monitors 118, 126. In an illustrative embodiment, video or audio portions of the content can be streamed to the set-top box devices 116, 124.

Further, the AQT switch 152 can be coupled to a video-on-demand importer server 158 that receives and stores television or movie content received at the acquisition tier 106 and communicates the stored content to the VOD server 136 at the client-facing tier 102 via the private network 110. Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When users issue requests for VOD content via the set-top box devices 116, 124, the requests can be transmitted over the access network 166 to the VOD server 136, via the CFT switch 130. Upon receiving such requests, the VOD server 136 can retrieve the requested VOD content and transmit the content to the set-top box devices 116,124 across the access network 166, via the CFT switch 130. The set-top box devices 116, 124 can transmit the VOD content to the television monitors 118, 126. In an illustrative embodiment, video or audio portions of VOD content can be streamed to the set-top box devices 116, 124.

FIG. 1 further illustrates that the operations and management tier 108 can include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 can be coupled to an OSS/BSS server 164 and to a simple network management protocol (SNMP) monitor 186 that monitors network devices within or coupled to the IPTV system 100. In a particular embodiment, the OMT switch 160 can communicate with the AQT switch 152 via the public network 112.

In an illustrative embodiment, the live acquisition server 154 can transmit content to the AQT switch 152, and the AQT switch 152, in turn, can transmit the content to the OMT switch 160 via the public network 112. In this embodiment, the OMT switch 160 can transmit the content to the TV2 server 162 for display to users accessing the user interface at the TV2 server 162. For example, a user can access the TV2 server 162 using a personal computer 168 coupled to the public network 112.

In operation, the system 100 may provide a list of video programs available to be downloaded to the set-top box 124. The system 100 may provide a linking command from a content provider or from a content sponsor to the set-top box 124. In addition, the system 100 may provide other data associated with video programs, which may include metadata describing content of video programs including, age appropriateness, content synopsis, length of broadcast, and other factors. The system 100 may provide one or more selected video programs to the set-top box 124 in response to selections of video programs to be linked.

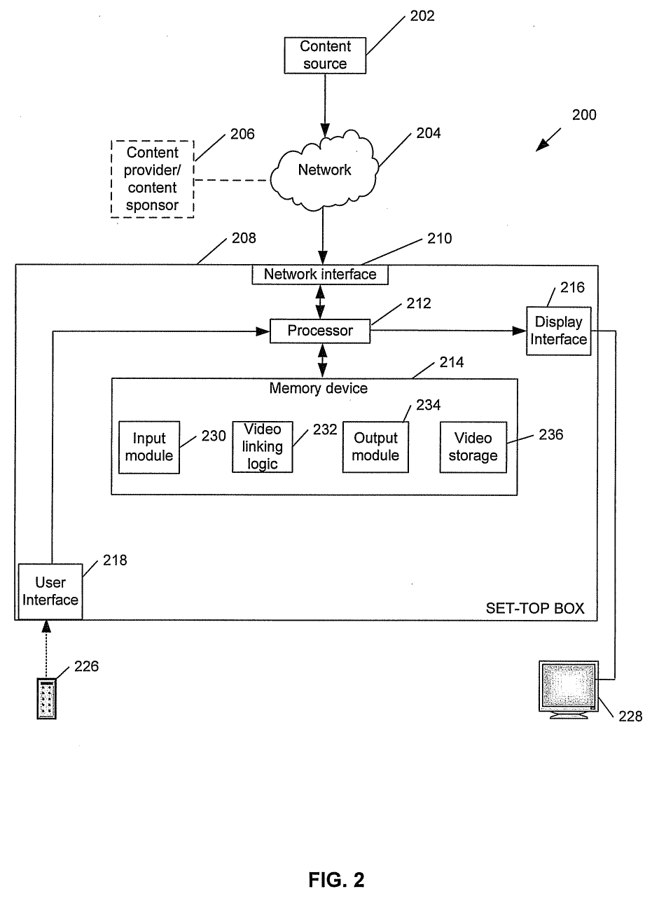

FIG. 2 is a diagram of a particular illustrative embodiment of a system 200 to provide video program sequenced output. The system 200 includes a content source 202 coupled to a network 204. The network 204 is coupled to a set-top box 208. Optionally, a content provider or content sponsor 206 may be coupled to the network 204. The set-top box 208 includes a network interface 210, a processor 212, a display interface 216, a memory device 214, and a user interface 218. The display interface 216 may be coupled to a display device 228, which may be a television or other display device. The user interface 218 may be coupled to a remote control device 226. The memory device 214 may include an input module 230, video linking logic 232, an output module 234, and video storage 236.

In a particular embodiment, the user interface 218 may receive a selection of a first video program from the remote control device 226. The user interface 218 may also receive a selection of a link command, and a selection of a second video program. The user interface 218 may convey this input to the processor 212. The processor 212 may receive the input from the user interface 218, utilizing the input module 230 in the memory device 214. The processor 212 may retrieve the first video program from the content source 202 via the network 204 or from the video storage 236. When the processor 212 retrieves the first video program from the content source 202 through the network 204, the first video program may be input to the set-top box 208 via the network interface 210. The processor 212 may retrieve the second video program from the content source 202 or from the video storage 236. After receiving the link command, the processor 212 may link the first video program with a second video program through use of the video linking logic 232. Alternatively, the processor 212 may store a record of the link command in the memory device 214 so that the link command may be invoked to commence playing the second video program after the first video program display is complete. The processor 212 may also store an address of the second video program to be accessed when the link command is invoked.

The processor 212 may output the first video program linked to the second video program utilizing the output module 234. The processor 212 may output the linked video programs to the display interface 216, which outputs the linked programs to the display device 228. The processor 212 may output the first video program, and after the first video program has been completely output, the processor 212 may begin to output the second video program. In this manner, when the first video program has finished showing on the display device 228, the second video program will begin to be displayed on the display device 228.

In a particular illustrative embodiment, the content provider or the content sponsor (content provider/content sponsor herein) 206 may provide the selection of the link command and the selection of the second video program. Consequently, the first video program, which has been selected by the user, may be linked to the second video program, which has been selected by the content provider/content sponsor.

In another particular illustrative embodiment, a user may provide the selection of the link command and the second video program via the remote control device 226. In this embodiment, the first video program may be linked to the second video program.

In a particular illustrative embodiment, the user or the content provider/content sponsor 206 may provide a plurality of linking commands that result in linking the first video program to the second video program, and the second video program to a third video program, etc. In this particular illustrative embodiment, upon receiving a command from, e.g., the user via the remote control device 226 to begin output, the processor 212 will output the first video program and, upon completion of outputting the first video program the processor 212, will commence outputting the second video program. Upon completion of outputting the second video program, the processor 212 will begin to output the third video program, etc. Video programs may be retrieved from the content source 202 via the network 204 through the network interface 210, may be retrieved from the video storage 236, or any combination thereof. In a particular illustrative embodiment, the content source 202 may include a network of content sources that that can supply video programs, e.g., IPTV system 100.

In a particular embodiment, the set-top box 208 may output a plurality of program titles to be displayed on the display device 228, each program title corresponding to a video program that is available to be output. The video programs available to be output may be stored in a video repository, such as the video storage 236 within the memory device 214, or stored at the content source 202, which may be an IPTV network, and which may be downloaded via the network 204, or any combination thereof.

In operation, the set-top box 208 may receive a selection of the first video program, the linking command, and the second video program from the remote control device 226, or from the content provider/content sponsor 206. The set-top box 208 may receive a command to begin outputting the linked video programs. Upon receiving the command to commence outputting the video programs, the processor 212 will begin to output the first video program to the display interface 216, which outputs the first video program to the display device 228. If no interrupt command is received, the processor 212 will complete outputting the first video program and will subsequently commence outputting of the second video program that has been linked to the first video program.

In a particular illustrative embodiment, the set-top box 208 may receive an interrupt command, which may originate from the remote control device 226. In a particular illustrative example, the interrupt command is received during the outputting of the first video program, causing the processor 212 to interrupt outputting of the first video program and begin to output the second video program that is linked to the first video program. The interrupt command may be invoked at any point during the display of the linked video programs, causing the video program currently being output to be interrupted and the subsequently linked video program to begin being output.

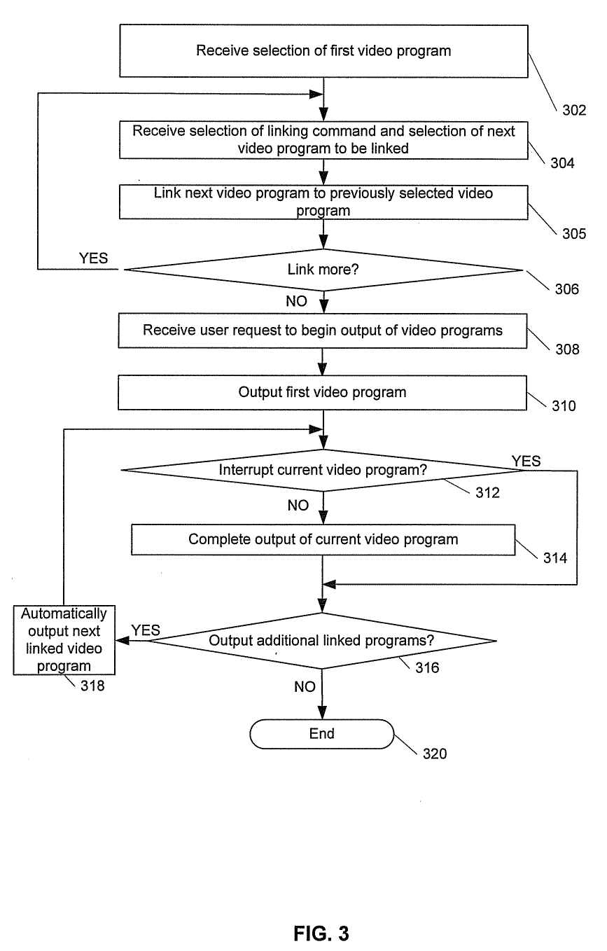

FIG. 3 is a block diagram of a particular embodiment of a method to provide video program sequenced output. At block 302, a selection of a first video program is received. Proceeding to block 304, a selection of a linking command and a next video program to be linked is received. Continuing to block 305, the next video program is linked to the previously selected video program. Moving to decision block 306, the method determines whether an additional video program is to be linked. For example, when an additional video program is to be linked, the method returns to block 304. At block 304, a linking command and a selection of the additional video program is received, and the additional video program is linked to the previously selected and linked video program. Proceeding to block 308, a user initiated request is received to output the first video program to a display device. Advancing to block 310, the first video program is output. Continuing on to decision block 312, the method determines whether to interrupt the video program currently being output. When the currently output video program is interrupted, for example, as a result of receiving an interrupt command, the method advances to decision block 316.

At decision block 316, the method determines whether additional linked video programs are to be output. When additional video programs are to be output, the method proceeds to block 318 and automatically begins outputting the next linked video program. The method returns to decision block 312, where the current video program may be interrupted, and a subsequently linked video program may commence being output.

When the current video program is not interrupted, at block 312 the method proceeds to block 314 and the current video program is output in its entirety. After the current video program is completed, the method proceeds to decision block 316 and determines whether additional linked video programs are to be output. When additional linked video programs are to be output, the method moves to block 318. When there are not additional linked programs, the method terminates at 320.

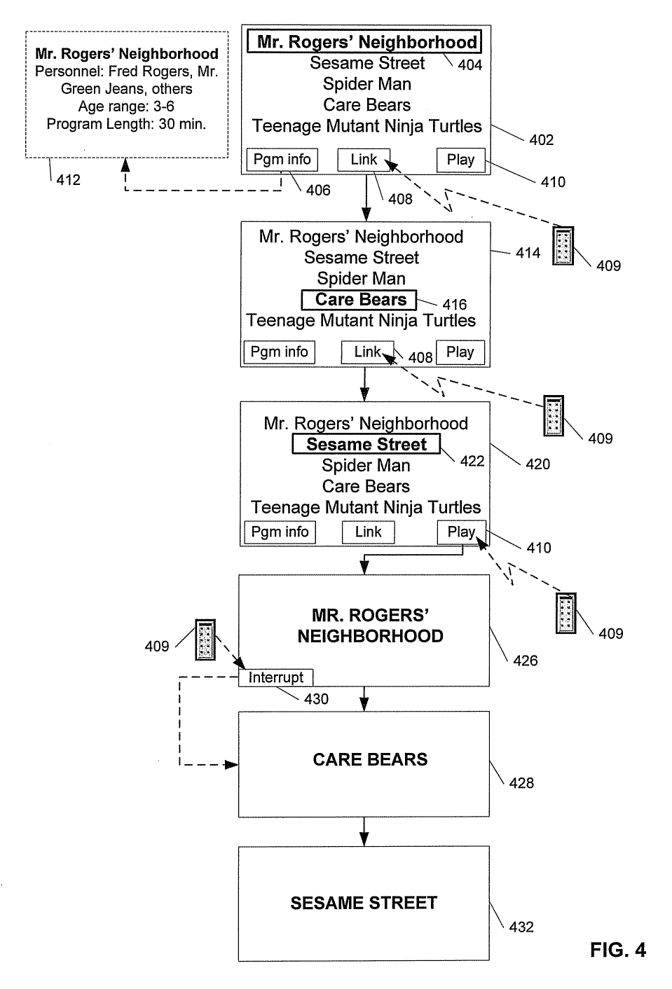

FIG. 4 is a particular illustrative embodiment of a graphical user interface to provide video program sequenced output. A display screen 402 displays names of video programs available for viewing. The available video programs may be stored at a set-top box, may be made available for downloading from a program source such as an IPTV source or from another source, or any other combination. In a particular illustrative embodiment, a user may select a video program to be included in viewing, such as “Mr. Rogers' Neighborhood” 404, via a remote control device 409, or via another selection mode.

The display screen 402 also includes a “program information” soft button 406, a “link” soft button 408, and a “play” soft button 410. The user may choose any of the soft buttons via the remote control device 409. In a particular illustrative embodiment, the user may select the program information button 406, which results in the display screen 402 displaying a program information screen 412. The program information screen 412 provides information pertaining to the selected video program. In the example shown, when the program information button 406 is selected, the program information screen 412 with additional information on “Mr. Rogers' Neighborhood” 404 is displayed on the display screen 402. In this manner the user, such as a parent, can receive program details pertaining to the selected video program in order to decide whether to include the selected video program among video programs to be linked. In a particular illustrative embodiment, prior to linking the user may deselect a previously selected video program and select another video program.

The user may select the link button 408 via the remote control device 409. In response to selection of the link button 408, the display device may display a screen 414 that includes names of video programs available to be linked. The user may select a second video program to be linked to the first video program via the remote control device 409. In display screen 414, the user has selected the video program “Care Bears” 416 to be linked to the first selected video program, “Mr. Rogers' Neighborhood” 404. The user may select the link button 408 via the remote control device 409 to link a third video program to the second selected video program. At each successive display screen, the user can select the program information button 406 to receive detailed information about a selected video program. Moving to display screen 420, the user has selected a third video program, “Sesame Street” 422, to be linked to “Care Bears” 416.

At the display screen 420, the user can select the play button 410 via the remote control display 409, resulting in the display device playing “Mr. Rogers' Neighborhood,” as in display screen 426. When showing of “Mr. Rogers' Neighborhood” is complete, the display device will automatically begin to play “Care Bears,” as in screen 428, and upon completion of “Care Bears,” the display device will automatically begin to play “Sesame Street,” shown in display screen 432. In a particular illustrative example, the user may select an interrupt soft button 430 while “Mr. Rogers' Neighborhood” is playing, causing the showing of “Mr. Rogers' Neighborhood” to be interrupted and “Care Bears” to begin playing, shown in display screen 428.

In operation, the apparatus and methods presented enable a user to quickly and easily link a series of video programs to be played sequentially. The user may select the video programs from among a store of video programs that may be available from an Internet Protocol Television (IPTV) network, from a video repository that is accessible via an IPTV network, or from any combination thereof. The video programs may also be available for retrieval from a video storage portion of memory within the set-top box. Video programs may also be available from other sources. The user may easily link the video programs to be displayed sequentially, determining a sequential order of viewing the video programs. In a particular illustrative embodiment, the user also has the option to interrupt any video program as it is being displayed, causing the next video program in the linked sequence to begin playing. By using the methods and apparatus described herein, a parent can quickly and easily create a sequence of video programs for children to watch.

The methods and systems described herein may also be expanded to include a “repeat” soft button, enabling the user to repeat the currently playing video program. Other soft buttons may be added, enabling the user to e.g., repeat all linked programs, shuffle the linked programs, remove a linked video program from the established sequence of video programs, or other functions.

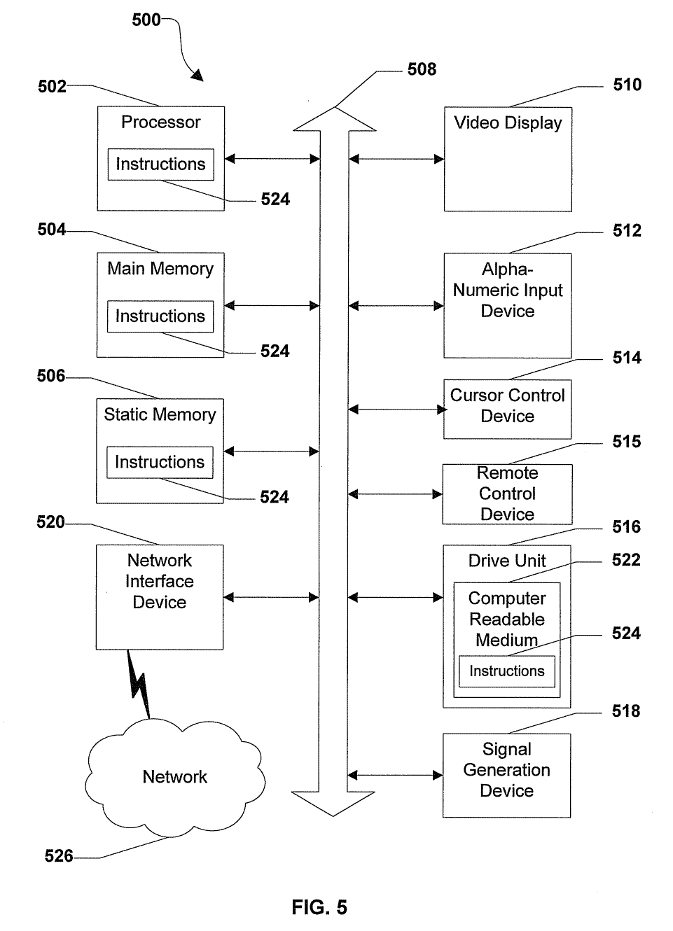

Referring to FIG. 5, an illustrative embodiment of a general computer system is shown and is designated 500. The computer system 500 can include a set of instructions that can be executed to cause the computer system 500 to perform any one or more of the methods or computer based functions disclosed herein. The computer system 500, or any portion thereof, may operate as a standalone device or may be connected, e.g., using a network, to other computer systems or peripheral devices, including a server or set-top box device, as shown in FIGS. 1-2.

In a networked deployment, the computer system may operate in the capacity of an IPTV server, such as a video server or application server, or a set-top box device. The computer system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 500 can be implemented using electronic devices that provide voice, video or data communication. Further, while a single computer system 500 is illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics-processing unit (GPU), or both. Moreover, the computer system 500 can include a main memory 504 and a static memory 506 that can communicate with each other via a bus 508. As shown, the computer system 500 may further include a video display unit 510, such as a liquid crystal display (LCD), an organic light emitting diode (OLED), a flat panel display, a solid state display, or a cathode ray tube (CRT). Additionally, the computer system 500 may include an input device 512, such as a keyboard, and a cursor control device 514, such as a mouse. The computer system 500 can also include a disk drive unit 516, a signal generation device 518, such as a speaker or remote control, and a network interface device 520.

In a particular embodiment, as depicted in FIG. 5, the disk drive unit 516 may include a computer-readable medium 522 in which one or more sets of instructions 524, e.g. software, can be embedded. Further, the instructions 524 may embody one or more of the methods or logic as described herein. In a particular embodiment, the instructions 524 may reside completely, or at least partially, within the main memory 504, the static memory 506, and/or within the processor 502 during execution by the computer system 500. The main memory 504 and the processor 502 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 524 or receives and executes instructions 524 responsive to a propagated signal, so that a device connected to a network 526 can communicate voice, video or data over the network 526. Further, the instructions 524 may be transmitted or received over the network 526 via the network interface device 520.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
receiving a selection of a first video program;
receiving a selection of a linking command to link the first video program to a second video program;
receiving a user request to output the first video program to a display device;
outputting the first video program in response to the user request; and
after displaying the first video program, automatically outputting the second video program to the display device without an additional user action.

2. The method of claim 1, further comprising:
receiving a second user request to link the second video program to a third video program; and
after the first video program and the second video program output have completed, automatically outputting the third video program.

3. The method of claim 1, further comprising:
receiving a selection of an interrupt command;
in response to receipt of the selection of the interrupt command, interrupting display of the first video program output; and
commencing output of the second video program.

4. The method of claim 1, further comprising:
receiving selections of a plurality of linking commands;
in response to receiving the selections of the plurality of linking commands, sequentially linking a plurality of video programs, wherein sequentially linking includes linking each of the plurality of video programs to an immediately preceding video program of the plurality of video programs; and
after the second video program output has completed, automatically outputting each of the plurality of video programs sequentially based on the links without additional user action.

5. The method of claim 1, further comprising outputting a list of available programs to the display device prior to receiving the selection of the first video program.

6. The method of claim 5, wherein at least one of the available video programs identified in the list of available video programs is stored at a storage portion of a set-top box.

7. The method of claim 1, wherein the linking command is received from a content provider or a content sponsor.

8. The method of claim 7, wherein the linking command specifies the second video program to be linked or a plurality of video programs to be linked sequentially, wherein the plurality of video programs includes the second video program.

9. The method of claim 1, wherein the selection of the linking command is received at a set-top box

10. The method of claim 1, wherein receiving the selection of the first video program further comprises receiving the selection of the first video program at a set-top box.

11. The method of claim 1, further comprising linking the first video program to the second video program.

12. An apparatus to link a plurality of video programs, the apparatus comprising:
an input module, the input module configured to receive input comprising a selection of a first video program, a selection of a link command, and a selection of a second video program;
video linking logic responsive to the input module, the video linking logic configured, in response to the input received at the input module, to link the first video program with the second video program to provide linked video programs; and
an output module responsive to the video linking logic, the output module configured to output the linked video programs such that the first video program is output in response to a user request and the second video program is automatically output without an additional user request after the first video program output has completed or is interrupted.

13. The apparatus of claim 12, wherein the input module is further configured to receive the selection of the link command from a remote control device.

14. The apparatus of claim 12, wherein the output module is further configured to output a Graphical User Interface (GUI) that includes a user selectable soft “play” button, and upon selection of the user selectable soft “play” button, the output module outputs the first video program to be displayed.

15. The apparatus of claim 12, wherein:
the input module is further configured to receive additional input, the additional input including another selection of the link command and a selection of a third video program;
the video linking logic is further configured, in response to the additional input received at the input module, to link the third video program to the second video program; and
the output module is configured to automatically output the third video program after outputting the second video program.

16. The apparatus of claim 12, further comprising video storage configured to store at least one of the first video program or the second video program, wherein the video linking logic is further configured to retrieve the first video program or the second video program from the video storage.

17. The apparatus of claim 16, wherein the output module is further configured to output a plurality of program titles, wherein each of the plurality of program titles corresponds to one of the video programs stored in the video storage.

18. The apparatus of claim 12, further comprising a network interface, wherein the network interface is configured to receive one or more video programs from an Internet Protocol Television (IPTV) network.

19. A computer readable medium comprising processor executable instructions that, when executed, cause the processor to:
receive a selection of a link command associated with a first video program and a second video program;
link the second video program to the first video program;
in response to receiving a user command, commence output of the first video program; and
at a conclusion of outputting the first video program, automatically commence output of the second video program linked to the first video program.

20. The computer readable medium of claim 19, further comprising additional processor executable instructions, that when executed, cause the processor to:
receive a selection of a third video program;
link the third video program to the second video program; and
at the conclusion of outputting the second video program, automatically commence output of the third video program.

21. The computer readable medium of claim 19, further comprising additional processor executable instructions that, when executed, cause the processor to retrieve the first and second video programs from a video repository.

22. The computer readable medium of claim 21, wherein the video repository is accessible via an Internet Protocol Television (IPTV) network.

23. The computer readable medium of claim 19, wherein the selection of the link command comprises a selection of a Graphical User Interface (GUI) element displayed on a display device.

24. The computer readable medium of claim 19, wherein the selection of the link command is received from a remote control device.
